(19) United States
(12) Patent Application Publication
(10) Pub. No.: US 2012/0179859 A1
(43) Pub. Date: Jul. 12, 2012

(54) NONVOLATILE MEMORY APPARATUS PERFORMING FTL FUNCTION AND METHOD FOR CONTROLLING THE SAME

(75) Inventors: Eui Jin KIM, Icheon-si Gyeonggi-do (KR); Jeong Soon KWAK, Icheon-si Gyeonggi-do (KR)

(73) Assignee: HYNIX SEMICONDUCTOR INC., Icheon-si (KR)

(21) Appl. No.: 13/337,479

(22) Filed: Dec. 27, 2011

(30) Foreign Application Priority Data
Jan. 11, 2011 (KR) 10-2011-0002653

(51) Int. Cl. G06F 12/02

(52) U.S. Cl. 711/103; 711/E12.008

(57) ABSTRACT

A nonvolatile memory apparatus includes: a memory controller coupled; and a memory area comprising a plurality of memory blocks controlled by the memory controller. The memory controller sets a plurality of physical blocks corresponding to the plurality of memory blocks, and sets a plurality of logical blocks which are mapping targets of the physical blocks such that a size of the logical blocks and a size of the physical blocks are asymmetrical.

### CROSS-REFERENCES TO RELATED APPLICATION

The present application claims priority under 35 U.S.C. §119(a) to Korean application number 10-2011-0002653, filed on Jan. 11, 2011, in the Korean Intellectual Property Office, which is incorporated herein by reference in its entirety as set forth in full.

### BACKGROUND

1. Technical Field

The present invention relates to a nonvolatile memory apparatus and a method for controlling the same, and more particularly, to a nonvolatile memory apparatus performing a flash is translation layer (FTL) function and a method for controlling the same.

2. Related Art

In general, a nonvolatile memory is used as a storage memory of various portable information devices. Furthermore, a solid state drive (SSD) using a NAND flash memory instead of a hard disk drive (HDD) in a personal computer (PC) has been recently launched on the market. Thus, it is expected that the SSD will make inroads into the HDD market.

Typically, an operation of controlling a data file in a semiconductor storage system such as the SSD includes writing, erasing, and updating actual data in a page designated by a logical address by which a data file may be identified. More specifically, a logical address and a physical address of a data storage area are mapped to each other through an FTL conversion.

If the logical address is referred to according to a command of a host (not illustrated), data may be written into, erased from, or read from a position designated by the physical address mapped to the logical address. The physical address indicates positional information of a page or sub block of a substantial (physical) memory area.

In such a mapping relation between the logical and physical blocks, when a write operation is frequently performed in the logical blocks such that all of the physical blocks are used, a new physical block should be allocated. Particularly, in the case of a system where a random write is frequently performed, a garbage collection or merge operation may be performed on a corresponding physical block, in order to perform one random write operation. Since such a garbage collection or merge operation requires a considerable amount of time, resources of the system may be inefficiently used.

### SUMMARY

A nonvolatile memory apparatus performing an FTL function and a method for controlling the same are described herein.

In one embodiment of the present invention, a nonvolatile memory apparatus includes: a memory controller; and a memory area comprising a plurality of memory blocks controlled by the memory controller. The memory controller sets a plurality of physical blocks corresponding to the plurality of memory blocks, and sets a plurality of logical blocks which are mapping targets of the physical blocks such that a size of the logical blocks and a size of the physical blocks are asymmetrical.

In another embodiment of the present invention, a nonvolatile memory apparatus includes: a memory controller; and a memory area comprising a plurality of physical blocks controlled by the memory controller. The memory controller sets a plurality of memory blocks corresponding to the plurality of memory blocks, and controls the physical blocks to always include pages which are not mapped, after garbage collection and merge, when setting a plurality of virtual logical blocks which are mapping targets of the physical blocks.

In another embodiment of the present invention, a method for controlling a nonvolatile memory apparatus includes the steps of: allocating a memory block such that a size of a logical block is smaller than a size of a physical block; performing mapping based on the size of the logical block; determining whether pages of the physical block corresponding to the logical block are writable or not; and differently allocating pages to be written, according to the determination result.

### BRIEF DESCRIPTION OF THE DRAWINGS

Features, aspects, and embodiments are described in conjunction with the attached drawings, in which:

FIG. 1 is a block diagram of a nonvolatile memory apparatus according to one embodiment;

FIGS. 2 and 3 are block diagrams illustrating a logical block and a physical block according to an embodiment; and

FIG. 4 is a flow chart showing a method for controlling the nonvolatile memory apparatus according to an embodiment.

### DETAILED DESCRIPTION

Hereinafter, a nonvolatile memory apparatus having an FTL function and a method for controlling the same according to the present invention will be described below with reference to the accompanying drawings through embodiments.

Each of the block diagrams may illustrate a part of a module, a segment, or a code including one or more executable instructions that may be encoded on a computer-readable medium for executing specific logical functions. Furthermore, in several alternative examples, the functions described in the respective blocks may be performed deviating from the sequence. For example, two blocks which are successively illustrated may be performed substantially at the same time or performed in a reverse order.

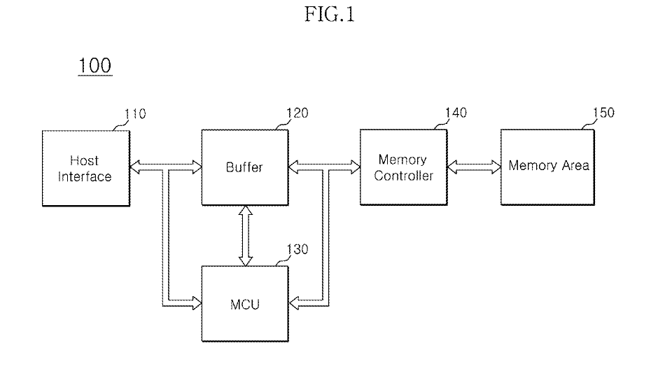

FIG. 1 is a block diagram of a nonvolatile memory apparatus according to one embodiment. Here, the nonvolatile memory apparatus may include a memory apparatus using a NAND flash memory device.

Referring to FIG. 1, the non-volatile memory apparatus 100 includes a host interface 110, a buffer 120, a micro control unit (MCU) 130, a memory controller 140, and a memory area 150.

First, the host interface 110 is coupled to the buffer 120. The host interface 110 transmits and receives a control command, an address signal, and a data signal between an external host (not illustrated) and the buffer 120. An interface method between the host interface 110 and the external host may include any one of serial advanced technology attachment (SATA), parallel advanced technology attachment (PATA), SCSI, Express Card, and PCI-Express, but is not limited thereto.

The buffer 120 is configured to buffer output signals of the host interface 110 and temporarily store mapping information between logical and physical memory addresses, block allocation information of the memory area, the erase number of blocks, and data received from outside. The buffer 120 may include a buffer using static random access memory (SRAM) or dynamic random access memory (DRAM).

The MCU 130 is configured to transmit and receive a control command, an address signal, and a data signal to and from the host interface 110 or control the memory controller 140 according to the signals.

The memory controller 140 is configured to receive input data and a write command from the host interface 110 and control the input data to be written into the memory area 150. Similarly, when receiving a read command from the host interface, the memory controller 140 reads data from the memory area 150 and controls the read data to be outputted to the outside.

In particular, the memory controller 140 according to the embodiment allocates memory blocks such that the size of physical blocks becomes asymmetric with the size of logical blocks, when mapping the logical blocks and the physical blocks. That is, the size of the logical blocks is set to be smaller than that of the physical blocks, in order to perform an FTL function. Therefore, page mapping is performed based on the number of effective pages comprising the logical block.

Furthermore, although a random write is frequently performed on a logical block and the logical block has a page which is repetitively referred to, the physical block having a larger size than the logical block may suppress the performance of a merge and garbage collection operation to some extent. In other words, when memory is configured such that physical blocks are of a larger size than logical blocks, merge and garbage collection operations may be performed less frequently. This will be described below in detail with reference to the accompanying drawings.

The memory area 150 is controlled by the memory controller 140 such that a write, erase, or read operation of data is performed. The memory area 150 may include a NAND flash memory device. In this embodiment of the present invention, a cell of the NAND flash memory device may include a single level cell (SLC) or multi level cell (MLC). The memory area 150 may include a plurality of chips each having a plurality of blocks. Each of the blocks includes a plurality of pages.

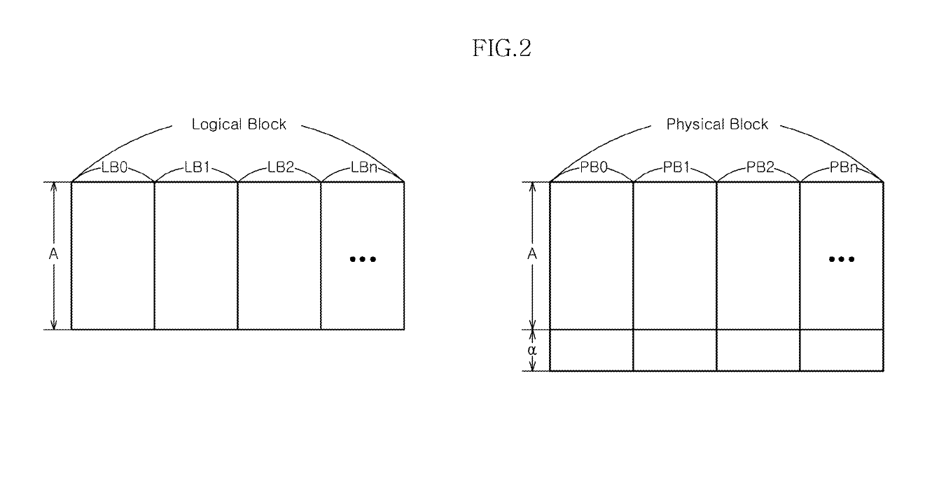

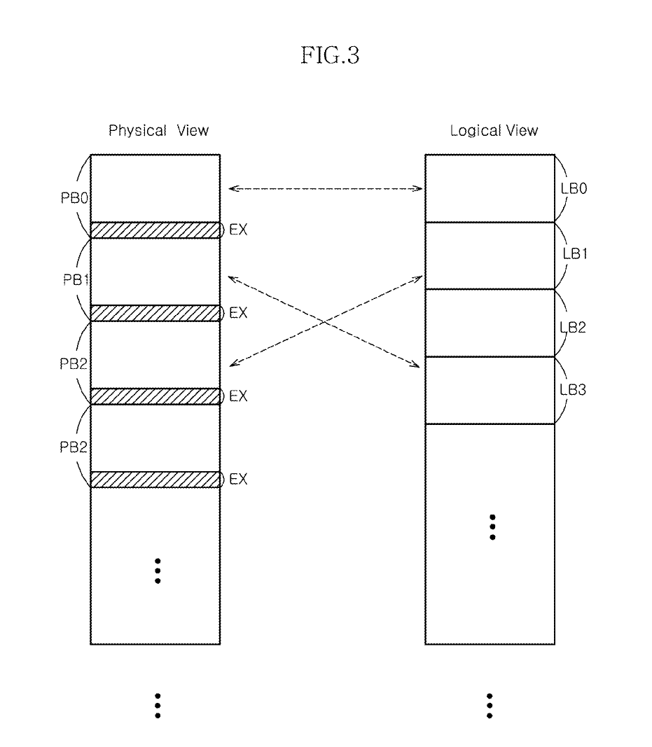

FIG. 2 is a block diagram illustrating a logical block and a physical block according to an embodiment. FIG. 3 is a block diagram illustrating an actual mapping relation between a logical block and a physical block.

Referring to FIGS. 2 and 3, a mapping method according to the embodiment will be described in detail.

A logical block group includes a plurality of logical blocks LB0, LB1, . . . .

Each of the logical blocks LB0, LB1, . . . has its own logical address.

A physical block group includes a plurality of physical blocks PB0, PB1, . . . .

The physical blocks PB0, PB1, . . . have a larger size than the logical blocks LB0, LB1, . . . . For example, when the logical blocks LB0, LB1, . . . have a size of A, the physical blocks PB0, PB1, . . . have a size of A+a.

Size of physical block=Size of logical block+a [Equation 1]

In other words, the logical blocks LB0, LB1, . . . and the physical blocks PB0, PB1, . . . according to an embodiment are set to have different sizes from each other, unlike a conventional nonvolatile memory apparatus.

Therefore, mapping is performed based on the size of the logical blocks LB0, LB1, . . . . That is, the pages of the physical blocks PB0, PB1, . . . are mapped based on the number of pages within the logical blocks LB0, LB1, . . . . Here, the size of the physical blocks PB0, PB1, . . . corresponds to the size of substantial memory blocks composing the memory area 150. For example, when it is assumed that each of the memory blocks within the memory area 150 includes 256 pages, each of the physical blocks PB0, PB1, . . . also includes 256 pages. However, each of the logical blocks LB0, LB1, . . . according to the embodiment is implemented in such a manner as to include a smaller number of pages than 256.

Referring to FIG. 3, actual data is written into, erased from, or updated into a page designated by a logical address (not illustrated). More specifically, an FTL conversion may map pages of a physical block to a number of pages of a logical block. When a logical address is referred to according to a command of the host (not illustrated), data may be written into, erased from, and read from a physical address that may be mapped to a logical address(es).

Here, a number of pages included in the logical block and the physical block having a mapping relation different from each other. That is, each of the physical blocks PB0, PB1, . . . further includes extra pages EX corresponding to a in Equation 1. Therefore, although a random write occurs, a page of the logical block is frequently referred to, and a frequent write operation is performed on the physical block such that after all of the mapped pages of the physical block are used, the physical block may still have extra pages. Therefore, the physical block may utilize the extra pages. More specifically, when all of the pages of the physical block in the mapping relation are used, pages of the corresponding logical block may be copied into the extra pages of the physical block. That is, since the physical block always has extra pages which are not mapped and stays in a standby mode, it is possible to suppress the frequency of garbage collection and merge by the number of extra pages. When data is written into the extra pages of the physical block, garbage collection and merge should be performed. At this time, the number of copy target pages of the physical block corresponds to the number of effective pages which substantially store data, and may coincide with the number of effective pages corresponding to the size of the logical block except for ineffective pages corresponding to a logical page which was repetitively referred. Therefore, although a merge operation of the physical block into a new free block (physical block) is performed, extra pages of the physical block always exist, in addition to the pages corresponding to the logical block size.

In the conventional nonvolatile memory apparatus, the sizes of the logical block and the physical block are set at 1:1.

Therefore, when effective pages are garbage collected to update data into new pages when a merge operation is required while storing and updating the data, the total number of effective pages may be equalized to the number of new pages. In this case, whenever new data is to be stored, that is, a random write is performed, the garbage collection may be performed again on the corresponding block; this frequent repeated performance of garbage collection may be inefficient. In a severe case, when a plurality of blocks is fully filled with effective data, a merge operation may be performed on the plurality of blocks, even for one write operation. As such, when the merge and garbage collection is frequently performed in a system in which a random write frequently occurs, the erase operation for the blocks is also frequently performed. This may age the system and reduce the lifetime of the system.

According to an embodiment, however, mapping is performed in such a manner that extra pages exist at all times even after merge or garbage collection. Therefore, although a random write continuously occurs, the extra pages may be effectively used to reduce the performance frequency of the merge and garbage collection.

Furthermore, since the mapping is performed based on the size of the logical block which is smaller than in a conventional nonvolatile memory apparatus, the size of the mapping table may be reduced. Therefore, it is possible to reduce the size of the storage area of the mapping table.

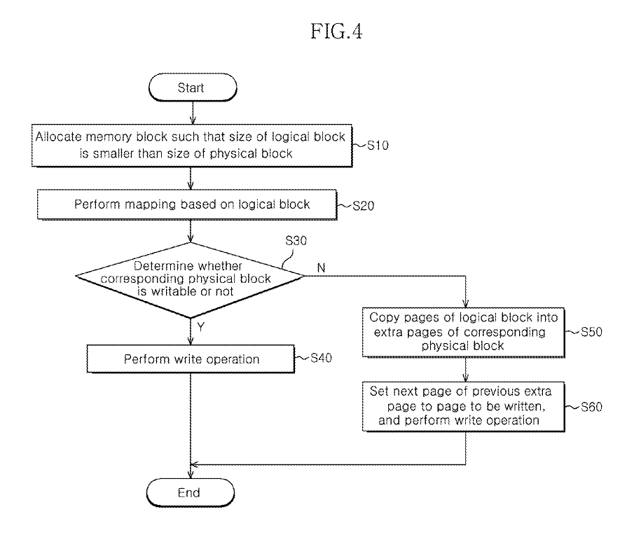

FIG. 4 is a flow charge showing an operation of the nonvolatile memory apparatus according to an embodiment.

Referring to FIGS. 1 to 4, memory blocks are allocated in such a manner that the size of logical blocks is set to be smaller than that of physical blocks, at step S10.

That is, the number of pages included in each of the logical blocks LB0, LB1, . . . is set to be smaller than the number of pages included in each of the physical blocks PB0, PB1, . . . .

Mapping between the logical block and the physical block is performed based on the number of pages comprising a logical block or blocks, at step S20.

Whether the pages of the physical block mapped to the pages of the logical block are writable or not is determined at step S30.

When it is determined that the pages are writable, a write operation is performed on the corresponding pages of the physical block, at step S40.

On the other hand, when it is determined that the pages are not writable, the pages of the logical block are copied into extra pages EX of the corresponding physical block at step S50.

When effective data exists in a traced extra page among the extra pages EX, the next page to the previous effective page is set to a page to be written, and a write operation is then performed, at step S60.

According to an embodiment of the present invention, the size of logical blocks is set to be smaller than the size of physical blocks forming a block, thereby suppressing the frequency of merge and garbage collection operations. Therefore, it is possible to improve the performance of a system in which a random write continuously occurs, without an additional resource or cost.

While certain embodiments have been described above, it will be understood to those skilled in the art that the embodiments described are by way of example only. Accordingly, the nonvolatile memory apparatus described herein should not be limited based on the described embodiments. Rather, the nonvolatile memory apparatus described herein should only be limited in light of the claims that follow when taken in conjunction with the above description and accompanying drawings.

What is claimed is:

1. A nonvolatile memory apparatus comprising:
a memory controller; and
a memory area comprising a plurality of memory blocks controlled by the memory controller,
wherein the memory controller sets a plurality of physical blocks corresponding to the plurality of memory blocks, and sets a plurality of logical blocks which are mapping targets of the physical blocks such that a size of the logical blocks and a size of the physical blocks are asymmetrical.

2. The nonvolatile memory apparatus according to claim 1, wherein the memory controller sets the memory blocks such that the size of the logical blocks is smaller than the size of the physical blocks.

3. The nonvolatile memory apparatus according to claim 2, wherein each of the physical blocks comprises a plurality of pages, and each of the logical blocks comprises a smaller number of pages than the plurality of pages included in the physical block.

4. The nonvolatile memory apparatus according to claim 3, wherein the memory controller performs a mapping based on the number of pages comprising a logical block.

5. The nonvolatile memory apparatus according to claim 3, wherein the memory controller controls data of the logical block to be written into pages of the physical block which have not been mapped.

6. A nonvolatile memory apparatus comprising:
a memory controller; and
a memory area comprising a plurality of physical blocks controlled by the memory controller,
wherein the memory controller sets a plurality of memory blocks corresponding to the plurality of memory blocks, and controls the physical blocks to always include pages which are not mapped, after garbage collection and merge, when setting a plurality of virtual logical blocks which are mapping targets of the physical blocks.

7. The nonvolatile memory apparatus according to claim 6, wherein the memory controller sets the memory blocks such that the size of the logical blocks and the size of the physical blocks are asymmetrical.

8. The nonvolatile memory apparatus according to claim 7, wherein the memory controller sets the memory blocks such that the size of the logical blocks is smaller than the size of the physical blocks.

9. The nonvolatile memory apparatus according to claim 8, wherein each of the physical blocks comprises a plurality of pages, and each of the logical blocks comprises a smaller number of pages than the plurality of pages included in the physical block.

10. The nonvolatile memory apparatus according to claim 8, wherein the memory controller performs mapping based on the number of pages comprising the logical block.

11. The nonvolatile memory apparatus according to claim 10, wherein the memory controller controls the number of effective pages within the physical block to be less than the page number of pages comprising the logical block through the mapping, when performing a garbage collection and merge operation.

12. A method for controlling a nonvolatile memory apparatus, comprising the steps of:
allocating a memory block such that a size of a logical block is smaller than a size of a physical block;
performing mapping based on the size of the logical block;
determining whether pages of the physical block corresponding to the logical block are writable or not; and
differently allocating pages to be written, according to the determination result.

13. The method according to claim 12, wherein, in the step of allocating the memory block,
a number of pages of the logical block is set to be smaller than a number of pages of the physical block.

14. The method according to claim 12, further comprising performing a write operation using extra pages of the corresponding physical block, according to the determination result.

15. The method according to claim 12, wherein memory mapping is performed based on the number of pages comprising the logical block.

16. The method according to claim 12, wherein all the pages of is the physical block corresponding to memory addresses of the logical block are used, writing further data into extra pages of the physical block.
